(19) United States
(12) Patent Application Publication
(10) Pub. No.: US 2024/0330442 A1
(43) Pub. Date: Oct. 3, 2024

(54) SYSTEMS AND METHODS FOR GENERATING RECOMMENDATIONS FOR CAUSES OF LABELING DETERMINATIONS THAT ARE GENERATED BY NON-DIFFERENTIABLE ARTIFICIAL INTELLIGENCE MODELS

(71) Applicant: Capital One Services, LLC, McLean, VA (US)

(72) Inventors: Brian BARR, Schenectady, NY (US); Samuel SHARPE, Cambridge, MA (US)

(73) Assignee: Capital One Services, LLC, McLean, VA (US)

(21) Appl. No.: 18/190,937

(22) Filed: Mar. 27, 2023

(51) Int. Cl. G06F 21/55

(52) U.S. Cl. CPC G06F 21/554; G06F 2221/034

(57) ABSTRACT

Methods and systems are described herein for novel uses and/or improvements to artificial intelligence applications. As one example, methods and systems are described herein related to adapting explainable artificial intelligence (XAI) to non-differentiable models (e.g., as used in intent prediction, fraud detection, and/or cyber incident detection). The systems and methods achieve this through the use of integrated gradients. For example, the systems and methods generate numerical approximations to gradients and integrals for non-differentiable models. These integrated gradients may then be used to apply XAI to non-differentiable models.

### BACKGROUND

In recent years, the use of artificial intelligence, including, but not limited to, machine learning, deep learning, etc. (referred to collectively herein as artificial intelligence models, models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. Notably, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution in intent prediction, fraud detection, and/or cyber incident detection.

### SUMMARY

Systems and methods are described herein for novel uses and/or improvements to artificial intelligence applications. As one example, methods and systems are described herein related to adapting explainable artificial intelligence (XAI) to non-differentiable models (e.g., as used in intent prediction, fraud detection, and/or cyber incident detection). For example, a non-differentiable model may not have a gradient and/or integral that is determinable.

For example, as artificial intelligence models become more advanced, humans are challenged to comprehend and retrace how these models may achieve a given result. The whole calculation process is turned into what is commonly referred to as a “black box” that is impossible to interpret. These black box models are created directly from the data and prevent users as well as other models from determining how the model arrived at a specific result.

One solution for overcoming this problem is through XAI. XAI refers to a host of modeling techniques that produce more explainable models, while maintaining a high level of learning performance (prediction accuracy), and enabling human users to understand, appropriately trust, and effectively manage the emerging generation of artificially intelligent partners. However, XAI has a fundamental flaw. Specifically, XAI, and conventional techniques thereof, are only practically applicable to differentiable models.

To overcome these technical deficiencies in adapting artificial intelligence models for this practical benefit, systems and methods are described herein for adapting non-differentiable models to be compatible with XAI algorithms. The systems and methods achieve this through the use of integrated gradients. For example, the systems and methods generate numerical approximations to gradients and integrals for non-differentiable models. These integrated gradients may then be used to apply XAI to non-differentiable models.

In some aspects, systems and methods are described for generating recommendations for causes of labeling determinations that are generated by non-differentiable artificial intelligence models. For example, the system may receive a first feature input corresponding to a dataset with an unknown label, wherein the first feature input comprises a plurality of values. The system may input the first feature input into an artificial intelligence model, wherein the artificial intelligence model is non-differentiable, and wherein the artificial intelligence model is trained to detect a known label based on a set of training data comprising labeled feature inputs corresponding to the known label. The system may receive a first prediction from the artificial intelligence model, wherein the first prediction indicates whether the first feature input corresponds to the known label. The system may receive a second prediction for the artificial intelligence model, wherein the second prediction indicates an approximated integrated gradient for the artificial intelligence model. The system may determine an effect of each value of the first feature input on the first prediction based on the approximated integrated gradient. The system may generate for display, on a user interface, a first recommendation for a cause of the known label in the dataset based on the effect of each value of the first feature input on the first prediction.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows a diagram for generating recommendations for causes of labeling determinations that are generated by non-differentiable artificial intelligence models, in accordance with one or more embodiments.

FIG. 2 shows a system featuring a model configured to generate recommendations for causes of labeling determinations that are generated by non-differentiable artificial intelligence models, in accordance with one or more embodiments.

FIG. 3 shows graphical representations of artificial intelligence models for generating recommendations for causes of labeling determinations that are generated by non-differentiable artificial intelligence models, in accordance with one or more embodiments.

FIG. 4 shows a flowchart for generating recommendations for causes of labeling determinations that are generated by non-differentiable artificial intelligence models, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

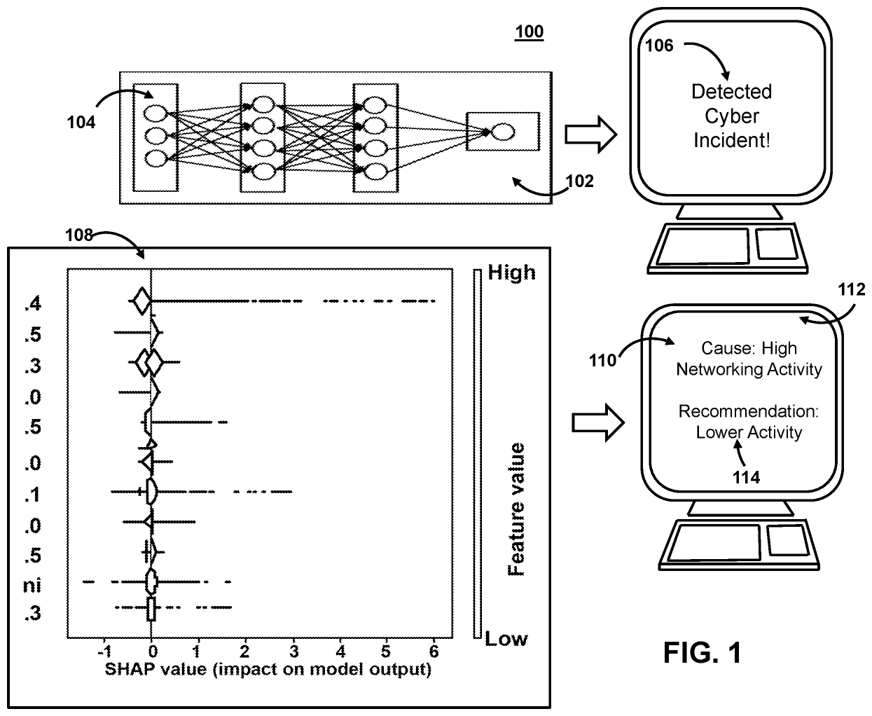

FIG. 1 shows a diagram for generating recommendations for causes of labeling determinations that are generated by non-differentiable artificial intelligence models, in accordance with one or more embodiments. For example, a differentiable model may comprise a model for which a derivative exists at each point in its domain. More specifically, differentiability may be described as when the slope of the tangent line equals the limit of the function at a given point. Similarly, for a differentiable model, an actual gradient and/or integral may be determined.

In contrast, a non-differentiable model may not have a gradient and/or integral that is determinable. For example, a model (or function) is non-differentiable when there is a cusp or a corner point in its graph. For example, consider the function f(x)=|x|, it has a cusp at x=0 hence it is not differentiable at x=0. In another example, a model is not differentiable at a point (e.g., a) if its graph has a vertical tangent line at a. The tangent line to the curve becomes steeper as x approaches a until it becomes a vertical line. Since the slope of a vertical line is undefined, the model (or function) is not differentiable in this case. In yet another example, a model (or function) may be differentiable if the function may be discontinuous at a point, the function may have a corner (or cusp) at a point, and/or the function may have a vertical tangent at a point.

For example, a Rectified Linear Unit (“ReLU”) is the most commonly used activation function in deep learning. The function returns 0 if the input is negative, but for any positive input, it returns that value back. Graphically, the ReLU function is composed of two linear pieces to account for non-linearities. A function is non-linear if the slope is not constant. So, the ReLU function is non-linear around 0, but the slope is always either 0 (for negative inputs) or 1 (for positive inputs). The ReLU function is continuous, but it is not differentiable because its derivative is O for any negative input.

However, determinable gradients and/or integrals are key to XAI, particularly those using SHAP (SHapley Additive exPlanations) values. SHAP values take a game-theoretic approach to providing predictive model explanations in the form of feature importances. In this setting, the features in a data point are considered “players” in a coalitional game that results in the model's prediction, which is interpreted as the “score” that that particular group of players achieved. Determining how to attribute this score across the various players' contributions would, in the predictive modeling setting, provide an explanation of the model's prediction that determines how each feature contributed to that outcome. With SHAP game theory, this attribution is done by asking how “leaving out” a particular player would change the score that the team achieves; however, most models fail to produce an output unless all of the features are specified. To avoid this, SHAP defines the result of a model, based on the gradients and/or integrals, when a subset of features is left out as the conditional expectation of the model's output over the left-out feature values given the fixed values of the left-in feature values.

However, computing this conditional expectation involves a deep understanding of the distribution of the features, which is not available in non-differentiable models as the rate of change is not determinable without the gradients and/or integrals. For example, SHAP values require an approximation and assumption that the features are independent. By doing so, the conditional expectation may be reduced to a marginal expectation, which may be approximated by sampling feature values independently from the training data.

Unfortunately, while formulating a SHAP system to be a model-agnostic explanation technique, the system still has major drawbacks: (1) the necessity of a sampling-based approach adds to the computational complexity of the algorithm, and (2) the approximation of independent features is unlikely to hold in most real datasets, and its effects on the fidelity of the explanations could be severe. For example, sampling-based approaches in practical applications would require exorbitant amounts of processing power. Likewise, resulting data sets (i.e., solutions in the practical applications) may not be “real” data sets in the practical application. For example, in a cyber-security application, the solution may provide a prediction and/or results having characteristics (e.g., network activity) that lie outside the characteristics that are achieved during the use of the practical application (e.g., network activity that is infeasible and/or otherwise an outlier to actual data (e.g., network activity that does not exist)).

For example, the methods and systems described herein overcome these drawbacks to enable SHAP values to be used in generating recommendations for causes of labeling determinations that are automatically detected by models such as unsupervised neural networks. To address these issues, the system deviates from the conventional model agnosticism of SHAP systems in order to avoid the potentially problematic assumption of feature independence. Additionally, the system's additional computational overhead is up front during model training to reduce the later complexity of generating explanations. The system achieves this by using a novel artificial neural network architecture that is trained to be able to not only make predictions but also compute the conditional expectations that are the theoretical foundation of the SHAP approach.

For example, SHAP values are beneficial in determining global interpretability-the collective SHAP values can show how much each predictor contributes, cither positively or negatively, to a target variable. For example, as shown in plot 108, the system may generate a variable importance plot, but it is able to show the positive or negative relationship for each variable with the target. The system may also determine local interpretability-each observation gets its own set of SHAP values, which greatly increases its transparency. For example, the system may generate a prediction and the contributions of the predictors. For example, while conventional variable importance algorithms only show the results across the entire population but not on each individual case, the local interpretability of the present system enables artificial intelligence model 102 to pinpoint and contrast the effects of the factors. This local interpretability is based on a derivative existing, and/or being determinable, at each point in the domain of the model. For example, the gradient of any line or curve (e.g., a line or curve based on the model and/or function) indicates the rate of change of one variable with respect to another. This rate of change for one variable can then be used to determine the conditional expectation of another. Similarly, the integral is a numerical value equal to the area under the graph of a function for some interval (e.g., step-size) or a new function, the derivative of which is the original function (indefinite integral).

To overcome the technical problem of the rate of change not being determinable, the system may generate an approximated rate of change (e.g., gradient) of an integral of a model or function. For example, a non-differentiable model does not allow for a derivative existing, and/or being determinable, at each point in the domain of the model. Each point (or a selection of points based on the step-size) may be selected and have an integral determined for it. The system may then approximate a gradient (e.g., generate an integrated gradient) based on the approximation.

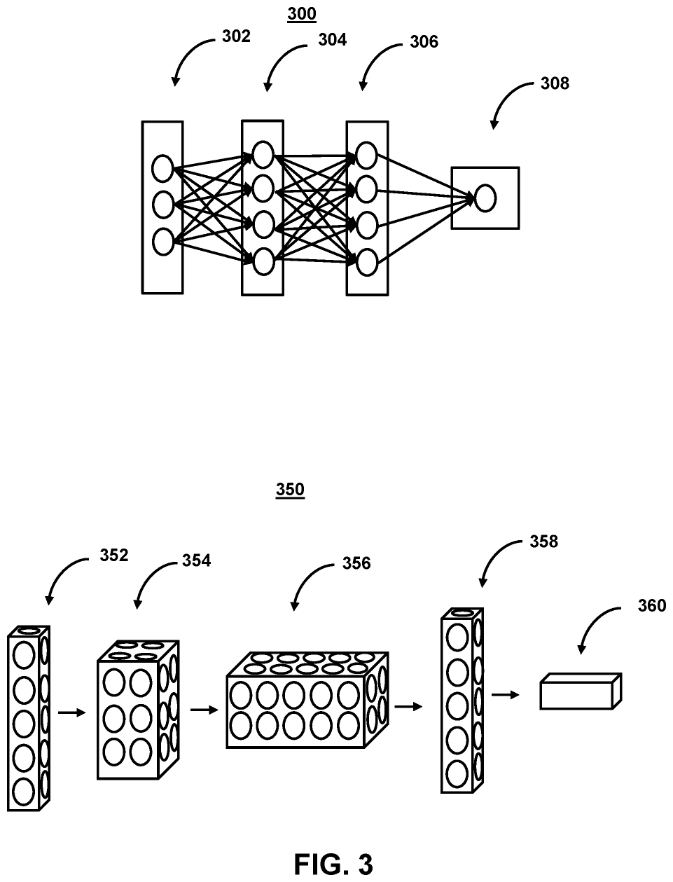

As shown in diagram 100, the system comprises a modified version of a fully connected neural network (e.g., artificial intelligence model 102). For example, input layer 104 to artificial intelligence model 102 may be augmented with a function that generates an approximated integrated gradient, one for each feature in the original input. The system then trains the neural network using gradient descent where, at each gradient descent step, the system selects the most important aspects of each value of the feature input for prediction of artificial intelligence model 102. As described in FIG. 3 below, artificial intelligence model 102 may have different architectures and uses such as classification with a convolutional neural network (CNN), with recurrent neural networks (RNN), and mixed CNN/RNN architectures.

The system learns to make accurate predictions in the circumstances where there is missing data, by using information about which features are missing to guide its training. Artificial intelligence model 102 may also predict conditional expectations based on the integrated gradients. These conditional expectations can then be used to predict SHAP values with no need for assuming feature independence or a more complex sampling-based approach. For example, artificial intelligence model 102 may generate data as expressed in plot 108. As shown in FIG. 1, plot 108 may include a list of feature importance in which variables are ranked in descending order. Plot 108 may also indicate the effect (e.g., a horizontal location may show whether the effect of that value is associated with a higher or lower prediction). Plot 108 may also show a relationship to an original value (e.g., a color may indicate whether a variable is high (in red) or low (in blue) for that feature input). Additionally, plot 108 may indicate a correlation such that a high measurement or other value of a variable has a high and positive effect on the triggering of the computer label.

It should be noted, that in some embodiments, plot 108 may be generated for display along with computer label 106 and/or recommendation 110. Alternatively, diagram 100 may generate recommendation 110 based on automatically processing the data underlying plot 108 (e.g., generate a recommendation without graphically representing the data in plot 108). In some embodiments, the system may generate an additional recommendation (e.g., recommendation 114) to take (or not take) an action.

For example, in instances where a known label comprises a detected fraudulent transaction, and wherein the plurality of values indicates a transaction history of a user, the system may determine a fraudulent transaction response based on the cause and generate for display a second recommendation for executing the fraudulent transaction response. In another example, in instances where a known label comprises a detected cyber incident, and wherein the plurality of values indicates networking activity of a user, the system may determine a cyber incident response based on the cause and generate for display a second recommendation for executing the cyber incident response. For example, a given cyber incident (e.g., a data breach, phishing attack, etc.) may be detected based on one or more activities detected in a network. Such activities may include any communication and/or activities exchanged and/or transmitted on a network. For example, network activity may comprise network traffic flowing in and out of one or more computer location. In particular, network activities may include messages from network protocols, packet transmission, device status events, etc. The system may compare these activities to a codebase (e.g., cyber incident management playbook) that features incident histories and procedures for cyber incident management to determine a cyber incident response. In another example, in instances where a known label comprises a refusal of a credit application, and wherein the plurality of values indicates credit history of a user, the system may determine a response based on the cause and generate for display a second recommendation for executing the response. In another example, in instances where a known label comprises a detected identity theft, and wherein the plurality of values indicates a user transaction history, the system may determine an identity theft response based on the cause and generate for display a second recommendation for executing the identity theft response.

The system may display this data on user interface 112. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user-generated content may include content created and/or consumed by a user. For example, user-generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user. For example, the system may generate a user profile for a user, user device, and/or network. The profile may include information collected related to intent prediction, fraud detection, cyber incident detection, and/or other applications. For example, the user profile may comprise historical information about previous activities that led to a positive, false-positive, and/or other label.

User profile data may also include a user characteristic. As referred to herein, “a user characteristic” may include information about a user, user device, network, and/or information included in a directory of stored user settings, preferences, and information for the user, user device, and/or network. For example, a user profile may have the settings for the user, user device, and/or network's installed programs and operating system. In some embodiments, the user profile may be a visual display of personal data associated with a specific user, or a customized desktop environment. In some embodiments, the user profile may be a digital representation of a person's identity. The data in the user profile may be generated based on the system actively or passively monitoring.

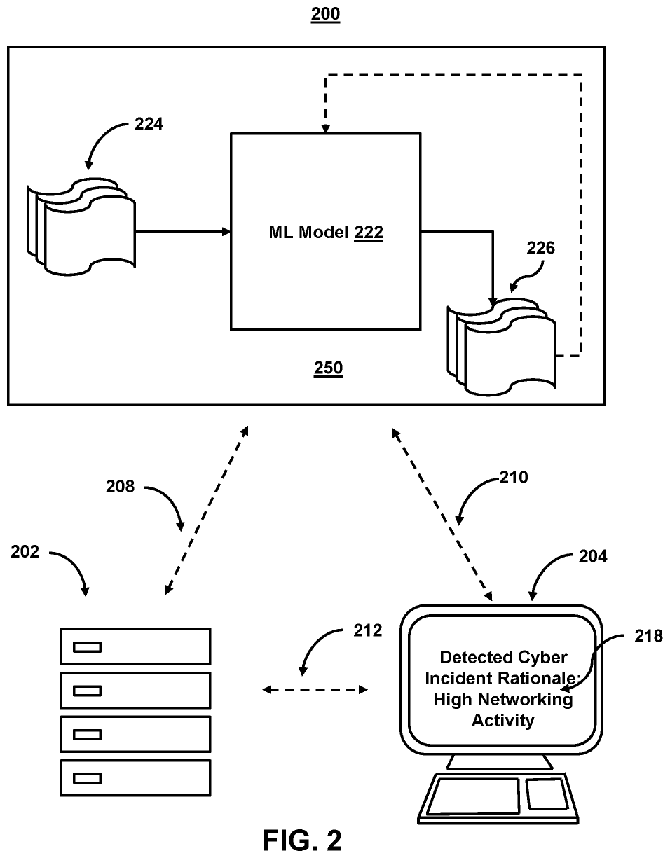

FIG. 2 shows a system featuring an artificial intelligence model configured to generate recommendations for causes of labeling determinations that are generated by non-differentiable artificial intelligence models, in accordance with one or more embodiments. As shown in FIG. 2, system 200 may include client device 202, client device 204, or other components. Each of client devices 202 and 204 may include any type of mobile terminal, fixed terminal, or other device. Each of these devices may receive content and data via input/output (I/O) paths and may also include processors and/or control circuitry to send and receive commands, requests, and other suitable data using the I/O paths. The control circuitry may comprise any suitable processing circuitry. Each of these devices may also include a user input interface and/or display for use in receiving and displaying data. By way of example, client devices 202 and 204 may include a desktop computer, a server, or other client device. Users may, for instance, utilize one or more of client devices 202 and 204 to interact with one another, one or more servers, or other components of system 200. It should be noted that, while one or more operations are described herein as being performed by particular components of system 200, those operations may, in some embodiments, be performed by other components of system 200. As an example, while one or more operations are described herein as being performed by components of client device 202, those operations may, in some embodiments, be performed by components of client device 204.

Each of these devices may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

FIG. 2 also includes communication paths 208, 210, and 212. Communication paths 208, 210, and 212 may include the Internet, a mobile phone network, a mobile voice or data network (e.g., a 4G or LTE network), a cable network, a public switched telephone network, or other types of communications networks or combinations of communications networks. Communication paths 208, 210, and 212 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

In some embodiments, system 200 may use one or more prediction models to generate recommendations for causes of labeling determinations that are generated by non-differentiable artificial intelligence models. For example, as shown in FIG. 2, system 200 may detect a computer label (e.g., label 104 (FIG. 1)) using model 222. The determination may be output shown as output 218 on client device 204. The system may include one or more neural networks (e.g., as discussed in relation to FIG. 3) or other models. System 200 may also provide a recommendation for the cause of the computer label (e.g., recommendation 110 (FIG. 1)) using model 222. The recommendation may be output shown as output 218 on client device 204.

As an example, with respect to FIG. 2, model 222 may take inputs 224 and provide outputs 226. The inputs may include multiple data sets such as a training data set and a test data set. For example, in some embodiments, the known label may comprise a detected fraudulent transaction, and the plurality of values may indicate a transaction history of a user. The test data may comprise data on transaction histories labeled with a known fraudulent transaction. In some embodiments, the known label comprises a detected cyber incident, and the plurality of values may indicate networking activity of a user. The test data may comprise data on networking activity labeled with known cyber incidents. In some embodiments, the known label may comprise a refusal of a credit application, and the plurality of values may indicate credit history of a user. The test data may comprise data on credit histories labeled with known refusals of credit applications. In some embodiments, the known label may comprise a detected identity theft, and the plurality of values may indicate a user transaction history. The test data may comprise data on transaction histories labeled with known instances of identity theft.

In one use case, outputs 226 may be fed back to model 222 as input to train model 222 (e.g., alone or in conjunction with user indications of the accuracy of outputs 226, labels associated with the inputs, or with other reference feedback information). In another use case, model 222 may update its configurations (e.g., weights, biases, or other parameters) based on its assessment of its prediction (e.g., outputs 226) and reference feedback information (e.g., user indication of accuracy, reference labels, or other information). In another use case, where model 222 is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the model 222 may be trained to generate better predictions. Model 222 may be trained to detect a known label based on a set of training data comprising labeled feature inputs corresponding to the known label. For example, model 222 may have classifications for the known computer labels.

System 200 also includes API layer 250. API layer 250 may allow the system to generate summaries across different devices. In some embodiments, API layer 250 may be implemented on client device 202 and/or client device 204. Alternatively or additionally, API layer 250 may reside on one or more of cloud components 310. API layer 250 (which may be a REST or web services API layer) may provide a decoupled interface to data and/or functionality of one or more applications. API layer 250 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services, as well as for exchanging information with partners in B2B transactions.

API layer 250 may use various architectural arrangements. For example, system 200 may be partially based on API layer 250, such that there is strong adoption of SOAP and RESTful web services, using resources like Service Repository and Developer Portal, but with low governance, standardization, and separation of concerns. Alternatively, system 200 may be fully based on API layer 250, such that separation of concerns between layers like API layer 250, services, and applications are in place.

In some embodiments, the system architecture may use a microservice approach. Such systems may use two types of layers: front-end layer and back-end layer where microservices reside. In this kind of architecture, the role of the API layer 250 may provide integration between front end and back end. In such cases, API layer 250 may use RESTful APIs (exposition to front end or even communication between microservices). API layer 250 may use AMQP (e.g., Kafka, RabbitMQ, etc.). API layer 250 may use incipient usage of new communications protocols such as gRPC, Thrift, etc.

In some embodiments, the system architecture may use an open API approach. In such cases, API layer 250 may use commercial or open source API platforms and their modules. API layer 250 may use a developer portal. API layer 250 may use strong security constraints applying WAF and DDOS protection, and API layer 250 may use RESTful APIs as standard for external integration.

FIG. 3 shows graphical representations of artificial intelligence models for generating recommendations for causes of labeling determinations that are generated by non-differentiable artificial intelligence models, in accordance with one or more embodiments. Model 300 illustrates an artificial intelligence model. Model 300 includes input layer 302. Model 300 also includes one or more hidden layers (e.g., hidden layer 304 and hidden layer 306). Model 300 may be based on a large collection of neural units (or artificial neurons). Model 300 loosely mimics the manner in which a biological brain works (e.g., via large clusters of biological neurons connected by axons). Each neural unit of a model 300 may be connected with many other neural units of model 300. Such connections can be enforcing or inhibitory in their effect on the activation state of connected neural units. In some embodiments, each individual neural unit may have a summation function which combines the values of all of its inputs together. In some embodiments, each connection (or the neural unit itself) may have a threshold function that the signal must surpass before it propagates to other neural units. Model 300 may be self-learning and trained, rather than explicitly programmed, and can perform significantly better in certain areas of problem-solving, as compared to traditional computer programs. During training, output layer 308 may correspond to a classification of model 300 (e.g., whether or not an alert label corresponds to a given value corresponding to the plurality of datasets) and an input known to correspond to that classification may be input into input layer 302. In some embodiments, model 300 may include multiple layers (e.g., where a signal path traverses from front layers to back layers). In some embodiments, backpropagation techniques may be utilized by model 300 where forward stimulation is used to reset weights on the “front” neural units. In some embodiments, stimulation and inhibition for model 300 may be more free-flowing, with connections interacting in a more chaotic and complex fashion. Model 300 also includes output layer 308. During testing, output layer 308 may indicate whether or not a given input corresponds to a classification of model 300 (e.g., whether or not an alert label corresponds to a given value corresponding to the plurality of datasets).

FIG. 3 also includes model 350, which is a convolutional neural network. The CNN is an artificial intelligence model that features one or more convolutional layers. As shown in model 350, input layer 352 may proceed to convolutional blocks 354 and 356 before being output to convolutional block 358. In some embodiments, model 350 may itself serve as an input to model 300. Model 350 may generate output 360, which may include data used to generate a recommendation (e.g., recommendation 110 (FIG. 1)).

In some embodiments, model 350 may implement an inverted residual structure where the input and output of a residual block (e.g., block 354) are thin bottleneck layers. A residual layer may feed into the next layer and directly into layers that are one or more layers downstream. A bottleneck layer (e.g., block 358) is a layer that contains few neural units compared to the previous layers. Model 350 may use a bottleneck layer to obtain a representation of the input with reduced dimensionality. An example of this is the use of autoencoders with bottleneck layers for nonlinear dimensionality reduction. Additionally, model 350 may remove non-linearities in a narrow layer (e.g., block 358) in order to maintain representational power. In some embodiments, the design of model 350 may also be guided by the metric of computation complexity (e.g., the number of floating point operations). In some embodiments, model 350 may increase the feature map dimension at all units to involve as many locations as possible instead of sharply increasing the feature map dimensions at neural units that perform downsampling. In some embodiments, model 350 may decrease the depth and increase the width of residual layers in the downstream direction.

Input layer 302 and input layer 352 may also feature one or more binary masks. For example, in some embodiments, an input layer to the artificial intelligence model may be augmented with a set of binary masks, one for each feature in the original input. The system then trains the neural network. For example, the system may use gradient descent where, at each gradient descent step, the system selects the integrated gradient. Alternatively or additionally, the system may systematically select a subset of integrated gradients based on one or more criteria. Accordingly, the system learns to make accurate predictions in the circumstances where there is missing data, by using information about which features are missing to guide its training. Once the system is trained, the system may make full predictions by simply setting integrated gradients to particular values and leaving the feature input unchanged. The system may also predict conditional expectations by setting the integrated gradients of any of the features to be left out to off and mangling the corresponding feature values. These conditional expectations can then be used to predict SHAP values with no need for assuming feature independence or a more complex sampling-based approach.

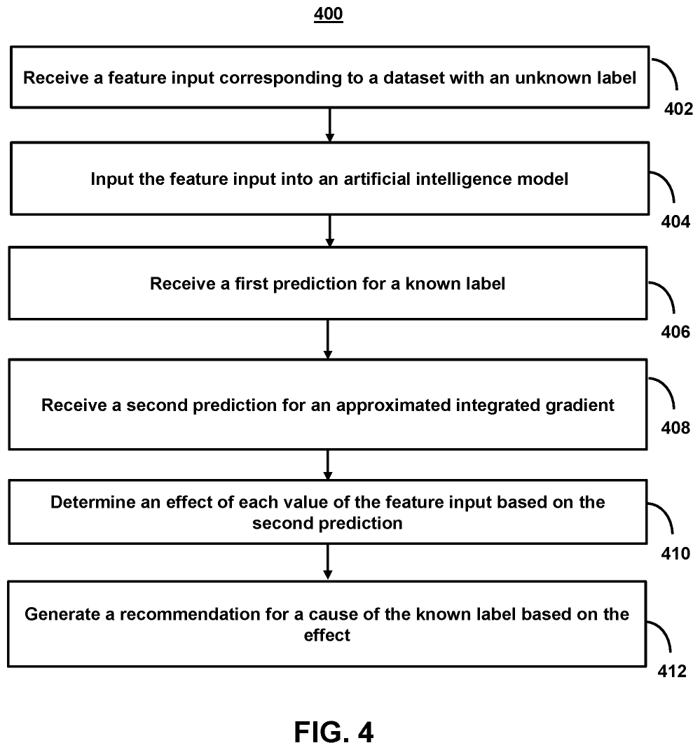

FIG. 4 shows a flowchart for generating recommendations for causes of labeling determinations that are generated by non-differentiable artificial intelligence models, in accordance with one or more embodiments. For example, process 400 may represent the steps taken by one or more devices as shown in FIGS. 1-3 for generating recommendations for causes of labeling determinations that are generated by non-differentiable artificial intelligence models. For example, process 400 deviates from the use of strictly differentiable model use in SHAP systems. To do so, process 400 may perform additional computational overhead up front (e.g., to generate integrated gradients) during model training to reduce the later complexity of generating explanations. Process 400 achieves this by using an artificial intelligence architecture that is trained to be able to not only make predictions, but also compute the conditional expectations that are based on integrated gradients.

At step 402, process 400 receives (e.g., using one or more components of system 200 (FIG. 2)) a feature input corresponding to a dataset with an unknown label. For example, the system may receive a first feature input corresponding to a dataset with an unknown label, wherein the first feature input comprises a plurality of values. For example, an unknown label may comprise data that is not yet labeled. As one example, a credit card transaction (e.g., currently unlabeled) may be labeled as fraudulent or not. In another example, an unknown label may correspond to data for a credit card application. The system may determine a label for this data (e.g., corresponding to a qualitative or quantitative assessment of strength of the application).

In some embodiments, the known label may comprise a detected fraudulent transaction, and the plurality of values may indicate a transaction history of a user. In some embodiments, the known label comprises a detected cyber incident, and the plurality of values may indicate networking activity of a user. In some embodiments, the known label may comprise a refusal of a credit application, and the plurality of values may indicate the credit history of a user. In some embodiments, the known label may comprise a detected identity theft, and the plurality of values may indicate a user transaction history.

At step 404, process 400 inputs (e.g., using one or more components of system 200 (FIG. 2)) the feature input into an artificial intelligence model. For example, the system may input the first feature input into an artificial intelligence model, wherein the artificial intelligence model is non-differentiable, and wherein the artificial intelligence model is trained to detect a known label based on a set of training data comprising labeled feature inputs corresponding to the known label.

In some embodiments, the artificial intelligence model may be trained using training data and/or test feature inputs. For example, the system may receive a test feature input, wherein the test feature input represents test values corresponding to datasets that correspond to the known label. The system may label the test feature input with the known label. The system may train the artificial intelligence model to detect the known label based on the test feature input. The system may train the artificial intelligence model to detect the conditional expectation for each of the plurality of datasets in an inputted feature input. For example, the system may apply a gradient descent and select integrated gradients corresponding to a respective one of a plurality of datasets to be toggled between an active state and an inactive state. In another example, the system may apply a gradient descent and select integrated gradients corresponding to a respective one of the plurality of datasets to set a respective value of the inputted feature input to an average value.

At step 406, process 400 receives (e.g., using one or more components of system 200 (FIG. 2)) a first prediction for a known label. For example, the system may receive a first prediction from the artificial intelligence model, wherein the first prediction indicates whether the first feature input corresponds to the known label. For example, the system may predict a labeled cyber incident corresponding to a given dataset. In some embodiments, the artificial intelligence model may be a ReLU model.

At step 408, process 400 receives (e.g., using one or more components of system 200 (FIG. 2)) a second prediction for an approximated integrated gradient. For example, the system may receive a second prediction for the artificial intelligence model, wherein the second prediction indicates an approximated integrated gradient for the artificial intelligence model. For example, the system may also predict conditional expectations using integrated gradients for any of the features to be left out to off and mangling the corresponding feature values.

In some embodiments, the system may use an approximated integrated gradient in order to estimate an actual gradient and/or integral, which may not be determined for non-differentiable models. For example, the system may determine a numerical approximation of gradients and integrals for the artificial intelligence model (and/or one or more feature inputs thereof). The system may then determine the approximated integrated gradient based on the numerical approximation of gradients and integrals.

In some embodiments, the system may use finite-difference methods to approximate gradients for the artificial intelligence model. For example, in numerical analysis, finite-difference methods (FDM) are a class of numerical techniques for solving differential equations by approximating derivatives with finite differences. Both the spatial domain and time interval (if applicable) are discretized, or broken into a finite number of steps, and the value of the solution at these discrete points is approximated by solving algebraic equations containing finite differences and values from nearby points.

FDM convert ordinary differential equations (ODE) or partial differential equations (PDE), which may be nonlinear, into a system of linear equations that can be solved by matrix algebra techniques. Modern computers can perform these linear algebra computations efficiently which, along with their relative ease of implementation, has led to the widespread use of FDM in modern numerical analysis. For example, the system may approximate a derivative for the artificial intelligence model using finite differences by solving differential equations. The system may then determine numerical approximations of gradients for the artificial intelligence model based on the derivative.

For example, an error in an FDM may be defined as the difference between the approximation and the exact analytical solution. The two sources of error in FDM are round-off error, the loss of precision due to computer rounding of decimal quantities, and truncation error or discretization error, the difference between the exact solution of the original differential equation and the exact quantity assuming perfect arithmetic (that is, assuming no round off). The local truncation error is proportional to the step sizes. The quality and duration of the simulated FDM solution depends on the discretization equation selection and the step sizes (time and space steps). The data quality and simulation duration increase significantly with smaller step sizes. Therefore, the system balances between data quality and simulation duration if necessary for practical usage. Accordingly, the system may select a predetermined step-size based on the application. Large time steps are useful for increasing simulation speed in practice. However, time steps which are too large may create instabilities and affect the data quality. For example, approximating the derivative for the artificial intelligence model using finite differences by solving differential equations may comprise the system receiving a predetermined step-size for a first application and using the predetermined step-size for approximating the derivative.

In some embodiments, the system may approximate a definite integral for a function corresponding to the artificial intelligence model. The system may then use the integrals to determine the numerical approximations of integrals for the artificial intelligence model. The system may use the e trapezoidal rule works to approximate the region under the graph of the function f(x) as a trapezoid and calculate its area. For example, the system may determine a result obtained by averaging the left and right Riemann sums of an area under a curve. The system may determine an even more accurate approximation by partitioning the integration interval, applying the trapezoidal rule to each subinterval, and summing the results. In practice, this “chained” (or “composite”) trapezoidal rule is usually what is meant by “integrating with the trapezoidal rule.” For example, the system may approximate an integral for the artificial intelligence model by approximating a region under a graph of a function that defines the artificial intelligence model. The system may determine numerical approximations of integrals for the artificial intelligence model based on the integral.

In some embodiments, the system may use Simpson's rule for numerical integration. For example, Simpson's rule is a Newton-Cotes formula for approximating the integral of a function using quadratic polynomials (i.e., parabolic arcs instead of the straight-line segments used in the trapezoidal rule). Simpson's rule can be derived by integrating a third-order Lagrange interpolating polynomial fit to the function at three equally spaced points. In particular, let the function f be tabulated at points x₀, x₁, and x₂ equally spaced by distance h, and denote fₙ=f(xₙ).

At step 410, process 400 determines (e.g., using one or more components of system 200 (FIG. 2)) an effect of each value of the feature input based on the second prediction. For example, the system may determine an effect of each value of the first feature input on the first prediction based on the approximated integrated gradient. For example, the system may determine the effect of each value of the first feature input on the first prediction by determining a SHAP value for each value of the first feature input. For example, the conditional expectations may be used to predict SHAP values with no need for assuming feature independence or a more complex sampling-based approach.

In some embodiments, the system may determine a SHAP value to determine the effect of each value of the first feature input. For example, a SHAP value may comprise the contribution of a feature value to the difference between the actual prediction and the mean prediction is the estimated SHAP value given the current set of feature values. For example, the system may determine a respective contribution of each value to a difference between an actual prediction and a mean prediction. The system may determine a respective SHAP value based on the respective contribution. The system may determine the effect of each value based on the respective contribution. The system may determine the effect of each value based on the respective contribution.

For example, as explained above in relation to FIG. 1, SHAP values are beneficial in determining global interpretability—the collective SHAP values can show how much each predictor contributes, either positively or negatively, to a target variable. As such, the system may generate a variable importance plot, but it is able to show the positive or negative relationship for each variable with the target. The system may also determine local interpretability, in which each observation gets its own set of SHAP values, which greatly increases its transparency. For example, the system may generate a prediction and the contributions of the predictors. While conventional variable importance algorithms only show the results across the entire population but not on each individual case, the local interpretability of the present system enables an artificial intelligence model to pinpoint and contrast the effects of the factors. This local interpretability is based on a derivative existing, and/or being determinable, at each point in the domain of the model. For example, the gradient of any line or curve (e.g., a line or curve based on the model and/or function) indicates the rate of change of one variable with respect to another. This rate of change for one variable can then be used to determine the conditional expectation of another. Similarly, the integral is a numerical value equal to the area under the graph of a function for some interval (e.g., step-size) or a new function, the derivative of which is the original function (indefinite integral). As the system have generated an approximated rate of change (e.g., gradient) of an integral of a model or function, the system may determine SHAP values for a non-differentiable model.

At step 412, process 400 generates (e.g., using one or more components of system 200 (FIG. 2)) for display, a recommendation for a cause of the known label based on the effect. For example, the system may generate for display, on a user interface, a recommendation for a cause of the known label in the dataset based on the effect of each value of the first feature input on the first prediction. Additionally or alternatively, the system may generate an additional recommendation for a response to the known label. For example, in instances where a known label comprises a refusal of a credit application, and wherein the plurality of values indicates credit history of a user, the system may determine a response based on the cause and generate for display a second recommendation for executing the response. In another example, in instances where a known label comprises a detected identity theft, and wherein the plurality of values indicates a user transaction history, the system may determine an identity theft response based on the cause and generate for display a second recommendation for executing the identity theft response.

For example, in embodiments where the known label comprises a detected fraudulent transaction, the system may identify the occurrence of the known label as well as indicate which value (e.g., a given transaction and/or characteristic thereof) caused the label. In embodiments where the known label comprises a detected cyber incident, the system may identify the occurrence of the known label as well as indicate which value (e.g., an instance of network activity and/or characteristic thereof) caused the label. In embodiments where the known label comprises a refusal of a credit application, the system may identify the occurrence of the known label as well as indicate which value (e.g., a given applicant or account value, user history category, regulation criteria, and/or characteristic thereof) caused the label. In embodiments where the known label comprises a detected identity theft, the system may identify the occurrence of the known label as well as indicate which value (e.g., a transaction and/or characteristic thereof) caused the label.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for generating recommendations for causes of labeling determinations that are generated by non-differentiable artificial intelligence models.

2. The method of the preceding embodiment, further comprising: receiving a first feature input corresponding to a dataset with an unknown label, wherein the first feature input comprises a plurality of values; inputting the first feature input into an artificial intelligence model, wherein the artificial intelligence model is non-differentiable, and wherein the artificial intelligence model is trained to detect a known label based on a set of training data comprising labeled feature inputs corresponding to the known label; receiving a first prediction from the artificial intelligence model, wherein the first prediction indicates whether the first feature input corresponds to the known label; receiving a second prediction for the artificial intelligence model, wherein the second prediction indicates an approximated integrated gradient for the artificial intelligence model; determining an effect of each value of the first feature input on the first prediction based on the approximated integrated gradient; and generating for display, on a user interface, a first recommendation for a cause of the known label in the dataset based on the effect of each value of the first feature input on the first prediction.

3. The method of any one of the preceding embodiments, further comprising: receiving a test feature input, wherein the test feature input represents test values corresponding to datasets that correspond to the known label; labeling the test feature input with the known label; and training the artificial intelligence model to detect the known label based on the test feature input.

4. The method of any one of the preceding embodiments, wherein receiving the second prediction for the artificial intelligence model further comprises: determining a numerical approximation of gradients and integrals for the artificial intelligence model; and determining the approximated integrated gradient based on the numerical approximation of gradients and integrals.

5. The method of any one of the preceding embodiments, wherein receiving the second prediction for the artificial intelligence model further comprises: approximating a derivative for the artificial intelligence model using finite differences by solving differential equations; and determining numerical approximations of gradients for the artificial intelligence model based on the derivative.

6. The method of any one of the preceding embodiments, wherein approximating the derivative for the artificial intelligence model using finite differences by solving differential equations further comprises: receiving a predetermined step-size for a first application; and using the predetermined step-size for approximating the derivative.

7. The method of any one of the preceding embodiments, wherein receiving the second prediction for the artificial intelligence model further comprises: approximating an integral for the artificial intelligence model by approximating a region under a graph of a function that defines the artificial intelligence model; and determining numerical approximations of integrals for the artificial intelligence model based on the integral.

8. The method of any one of the preceding embodiments, wherein receiving the second prediction for the artificial intelligence model further comprises: approximating an integral for the artificial intelligence model by approximating an integrand f(x) by a quadratic interpolant P(x) of a function that defines the artificial intelligence model; and determining numerical approximations of integrals for the artificial intelligence model based on the integral.

9. The method of any one of the preceding embodiments, wherein determining the effect of each value of the first feature input on the first prediction comprises determining a SHAP (SHapley Additive explanations) value for each value of the first feature input.

10. The method of any one of the preceding embodiments, wherein determining the effect of each value of the first feature input on the first prediction based on the approximated integrated gradient further comprises: determining a respective contribution of each value to a difference between an actual prediction and a mean prediction; determining a respective SHAP value based on the respective contribution; and determining the effect of each value based on the respective contribution.

11. The method of any one of the preceding embodiments, wherein the known label comprises a detected fraudulent transaction, and wherein the plurality of values indicates a transaction history of a user, and wherein the method further comprises: determining a fraudulent transaction response based on the cause; and generating for display a second recommendation for executing the fraudulent transaction response.

12. The method of any one of the preceding embodiments, wherein the known label comprises a detected cyber incident, and wherein the plurality of values indicates networking activity of a user, and wherein the method further comprises: determining a cyber incident response based on the cause; and generating for display a second recommendation for executing the cyber incident response.

13. The method of any one of the preceding embodiments, wherein the known label comprises a refusal of a credit application, and wherein the plurality of values indicates credit history of a user, and wherein the method further comprises: determining a response based on the cause; and generating for display a second recommendation for executing the response.

14. The method of any one of the preceding embodiments, wherein the known label comprises a detected identity theft, and wherein the plurality of values indicates a user transaction history, and wherein the method further comprises: determining an identity theft response based on the cause; and generating for display a second recommendation for executing the identity theft response.

15. A tangible, non-transitory, machine-readable medium storing instructions that, when executed by a data processing apparatus, cause the data processing apparatus to perform operations comprising those of any of embodiments 1-14.

16. A system comprising one or more processors; and memory storing instructions that, when executed by the processors, cause the processors to effectuate operations comprising those of any of embodiments 1-14.

17. A system comprising means for performing any of embodiments 1-14.

What is claimed is:

1. A system for generating recommendations for causes of computer security labels that are generated by non-differentiable artificial intelligence models processing datasets built by monitoring network activity, comprising:
one or more processors; and
a non-transitory, computer-readable medium comprising instructions recorded thereon that when executed by the one or more processors cause operations comprising:
receiving a first feature input corresponding to a dataset with an unknown label, wherein the first feature input comprises a plurality of values, and wherein the plurality of values indicates networking activity of a user;
inputting the first feature input into an artificial intelligence model, wherein the artificial intelligence model is non-differentiable, wherein the artificial intelligence model is trained to detect a known label based on a set of training data comprising labeled feature inputs corresponding to the known label, and wherein the known label comprises a detected cyber incident;
receiving a first prediction from the artificial intelligence model, wherein the first prediction indicates whether the first feature input corresponds to the known label;
receiving a second prediction for the artificial intelligence model, wherein the second prediction indicates an approximated integrated gradient for the artificial intelligence model;
determining an effect of each value of the first feature input on the first prediction based on the approximated integrated gradient;
generating for display, on a user interface, a recommendation for a cause of the known label in the dataset based on the effect of each value of the first feature input on the first prediction; and
determining a cyber incident response based on the cause; and
generating for display a second recommendation for executing the cyber incident response.

2. A method for generating recommendations for causes of labeling determinations that are generated by non-differentiable artificial intelligence models, comprising:
receiving a first feature input corresponding to a dataset with an unknown label, wherein the first feature input comprises a plurality of values;
inputting the first feature input into an artificial intelligence model, wherein the artificial intelligence model is non-differentiable, and wherein the artificial intelligence model is trained to detect a known label based on a set of training data comprising labeled feature inputs corresponding to the known label;
receiving a first prediction from the artificial intelligence model, wherein the first prediction indicates whether the first feature input corresponds to the known label;
receiving a second prediction for the artificial intelligence model, wherein the second prediction indicates an approximated integrated gradient for the artificial intelligence model;
determining an effect of each value of the first feature input on the first prediction based on the approximated integrated gradient; and
generating for display, on a user interface, a first recommendation for a cause of the known label in the dataset based on the effect of each value of the first feature input on the first prediction.

3. The method of claim 2, further comprising:
receiving a test feature input, wherein the test feature input represents test values corresponding to datasets that correspond to the known label;
labeling the test feature input with the known label; and
training the artificial intelligence model to detect the known label based on the test feature input.

4. The method of claim 2, wherein receiving the second prediction for the artificial intelligence model further comprises:
determining a numerical approximation of gradients and integrals for the artificial intelligence model; and
determining the approximated integrated gradient based on the numerical approximation of gradients and integrals.

5. The method of claim 2, wherein receiving the second prediction for the artificial intelligence model further comprises:
approximating a derivative for the artificial intelligence model using finite differences by solving differential equations; and
determining numerical approximations of gradients for the artificial intelligence model based on the derivative.

6. The method of claim 5, wherein approximating the derivative for the artificial intelligence model using finite differences by solving differential equations further comprises:
receiving a predetermined step-size for a first application; and
using the predetermined step-size for approximating the derivative.

7. The method of claim 2, wherein receiving the second prediction for the artificial intelligence model further comprises:
approximating an integral for the artificial intelligence model by approximating a region under a graph of a function that defines the artificial intelligence model; and
determining numerical approximations of integrals for the artificial intelligence model based on the integral.

8. The method of claim 2, wherein receiving the second prediction for the artificial intelligence model further comprises:
approximating an integral for the artificial intelligence model by approximating an integrand f(x) by a quadratic interpolant P(x) of a function that defines the artificial intelligence model; and
determining numerical approximations of integrals for the artificial intelligence model based on the integral.

9. The method of claim 2, wherein determining the effect of each value of the first feature input on the first prediction comprises determining a SHAP (SHapley Additive exPlanations) value for each value of the first feature input.

10. The method of claim 2, wherein determining the effect of each value of the first feature input on the first prediction based on the approximated integrated gradient further comprises:
determining a respective contribution of each value to a difference between an actual prediction and a mean prediction;
determining a respective SHAP value based on the respective contribution; and
determining the effect of each value based on the respective contribution.

11. The method of claim 2, wherein the known label comprises a detected fraudulent transaction, wherein the plurality of values indicates a transaction history of a user, and wherein the method further comprises:
determining a fraudulent transaction response based on the cause; and
generating for display a second recommendation for executing the fraudulent transaction response.

12. The method of claim 2, wherein the known label comprises a detected cyber incident, wherein the plurality of values indicates networking activity of a user, and wherein the method further comprises:
determining a cyber incident response based on the cause; and
generating for display a second recommendation for executing the cyber incident response.

13. The method of claim 2, wherein the known label comprises a refusal of a credit application, wherein the plurality of values indicates a credit history of a user, and wherein the method further comprises:
determining a response based on the cause; and
generating for display a second recommendation for executing the response.

14. The method of claim 2, wherein the known label comprises a detected identity theft, wherein the plurality of values indicates a user transaction history, and wherein the method further comprises:
determining an identity theft response based on the cause; and
generating for display a second recommendation for executing the identity theft response.

15. A non-transitory, computer-readable medium comprising instructions that, when executed by one or more processors, cause operations comprising:
receiving a first feature input corresponding to a dataset with an unknown label, wherein the first feature input comprises a plurality of values;
inputting the first feature input into an artificial intelligence model, wherein the artificial intelligence model is trained to detect a known label based on a set of training data comprising labeled feature inputs corresponding to the known label;
receiving a first prediction from the artificial intelligence model, wherein the first prediction indicates whether the first feature input corresponds to the known label;
receiving a second prediction for the artificial intelligence model, wherein the second prediction indicates an approximated integrated gradient for the artificial intelligence model;
determining an effect of each value of the first feature input on the first prediction based on the approximated integrated gradient; and
generating for display, on a user interface, a recommendation for a cause of the known label in the dataset based on the effect of each value of the first feature input on the first prediction.

16. The non-transitory, computer-readable medium of claim 15, further comprising:
receiving a test feature input, wherein the test feature input represents test values corresponding to datasets that correspond to the known label;
labeling the test feature input with the known label; and
training the artificial intelligence model to detect the known label based on the test feature input.

17. The non-transitory, computer-readable medium of claim 15, wherein receiving the second prediction for the artificial intelligence model further comprises:
determining a numerical approximation of gradients and integrals for the artificial intelligence model; and
determining the approximated integrated gradient based on the numerical approximation of gradients and integrals.

18. The non-transitory, computer-readable medium of claim 15, wherein receiving the second prediction for the artificial intelligence model further comprises:
approximating a derivative for the artificial intelligence model using finite differences by solving differential equations; and
determining numerical approximations of gradients for the artificial intelligence model based on the derivative.

19. The non-transitory, computer-readable medium of claim 18, wherein approximating the derivative for the artificial intelligence model using finite differences by solving differential equations further comprises:
receiving a predetermined step-size for a first application; and
using the predetermined step-size for approximating the derivative.

20. The non-transitory, computer-readable medium of claim 15, wherein receiving the second prediction for the artificial intelligence model further comprises:
approximating an integral for the artificial intelligence model by approximating a region under a graph of a function that defines the artificial intelligence model; and
determining numerical approximations of integrals for the artificial intelligence model based on the integral.
